(19) United States
(12) Patent Application Publication
(10) Pub. No.: US 2006/0221598 A1
(43) Pub. Date: Oct. 5, 2006

(54) Pick-up tool with hands-free lighting

(76) Inventors: Andrew March, Lake Forest, CA (US); Jared Nathanson, Dana Point, CA (US)

Correspondence Address: THE MAXHAM FIRM, 750 "B" STREET, SUITE 3100, SAN DIEGO, CA, 92101, US

(21) Appl. No.: 11/097,043

(22) Filed: Mar. 31, 2005

(51) Int. Cl. B25B 23/18

(52) U.S. Cl. 362/119; 362/120; 362/276; 362/802

(57) ABSTRACT

In accordance with one embodiment, a pick-up tool includes an elongated hollow body having first and second pick-up fingers extending divergently outward from a distal end of the body. Engagement elements, such as rubber cups, may be individually located at terminating outer ends of each of the first and second pick-up fingers. The pick-up tool further includes first and second linkages respectively extending from the first and second pick-up fingers. A lighting element is coupled to the body, a magnet is coupled to the first linkage, and a switch, preferably a reed switch is coupled to the distal end of the body. The switch causes the lighting element to emit light for a predetermined period of time upon detecting the magnet at an effectively close distance relative to the switch. A lever or trigger pivotally coupled to the body may be used for drawing the first and second linkages rearward, causing the engagement elements to move closer together, and substantially simultaneously causing the magnet to effectively actuate the switch.

### BACKGROUND OF THE INVENTION

1. Field of the Invention

The present invention relates generally to a pick-up tool, and in particular to a pick-up tool having a lighting assembly mounted thereon.

2. Discussion of the Related Art

There are a wide variety of tools designed for picking up objects or manipulating objects from a distance. One common application for such tools is use by maintenance workers to pick-up debris for subsequent disposal. A tool with an elongated handle allows manipulation of the object without the need to bend over or to directly handle the material. Such tools are also useful for individuals that have physical limitations that may impede their ability to bend over and reach the ground. There are also numerous household applications for such tools including retrieval of materials from high shelves or from under furniture. Another common application for these tools is for changing light bulbs from recessed lighting fixtures.

In general, pick-up tools include an elongated shaft having a handle and a control device on one end, and engagement elements on the opposite end. Some sort of linkage typically couples the engagement elements to the control element. The user of these tools may manipulate the controller, which may be constructed as a lever or trigger, to operate the engagement elements that are provided on the opposite end of the elongated shaft. The engagement elements may include arrangements such as claws, arms, scoops, calipers, tongs, blades or cups. In typical designs, a control lever or trigger pulls an internal linkage that draws together the engagement elements that are biased apart by springs.

Situations arise in which the user is forced to locate an object for retrieval in a dimly lit area. Examples of such areas include closets, attics or crawlspaces, under a bed, behind furniture, tool sheds, pantries, outdoors at night, and the like. While existing devices have enjoyed considerable success, such devices are not especially suited for use in low-light and no-light environments.

### SUMMARY OF THE INVENTION

In accordance with one embodiment, a pick-up tool includes an elongated hollow body having first and second pick-up fingers extending divergently outward from a distal end of the body. Engagement elements, such as rubber cups, may be individually located at terminating outer ends of each of the first and second pick-up fingers. The pick-up tool further includes first and second linkages respectively extending from the first and second pick-up fingers. A lighting element is coupled to the body, a magnet is coupled to the first linkage, and a switch, preferably a reed switch is coupled to the distal end of the body. The switch causes the lighting element to emit light for a predetermined period of time upon detecting the magnet at an effectively close distance relative to the switch. A lever or trigger pivotally coupled to the body may be used for drawing the first and second linkages rearward, causing the engagement elements to move closer together, and substantially simultaneously causing the magnet to effectively actuate the switch.

### BRIEF DESCRIPTION OF THE DRAWING

The above and other aspects, features, and advantages of the present invention will become more apparent upon consideration of the following description of preferred embodiments, taken in conjunction with the accompanying drawing figures, wherein:

FIG. 1 is a perspective view of a pick-up tool having an attached lighting assembly, in accordance with an embodiment of the present invention;

FIG. 2 is a close-up top-view of the distal end of the pick-up tool of FIG. 1, and is shown in the open position;

FIG. 3 is a close-up top-view of the distal end of the pick-up tool of FIG. 1, and is shown in the closed position;

FIG. 4 is a partial close-up side-view of the pick-up tool of FIG. 2, showing the light in the off condition;

FIG. 5 is a partial close-up side-view of the pick-up tool similar to FIG. 4, showing the light actuated; and

FIG. 6 is an exploded perspective view of the various components of an exemplary lighting assembly which may be used in conjunction with the pick-up tool of FIG. 1.

### DETAILED DESCRIPTION OF PREFERRED EMBODIMENTS

In the following detailed description, reference is made to the accompanying drawing figures which form a part hereof, and which show by way of illustration specific embodiments of the invention. It is to be understood by those of ordinary skill in this technological field that other embodiments may be utilized, and that structural, electrical, as well as procedural changes may be made without departing from the scope of the present invention. As a matter of convenience, various embodiments of the invention will be described using exemplary materials, sizes, shapes, and dimensions, but the present invention is not limited to the stated examples.

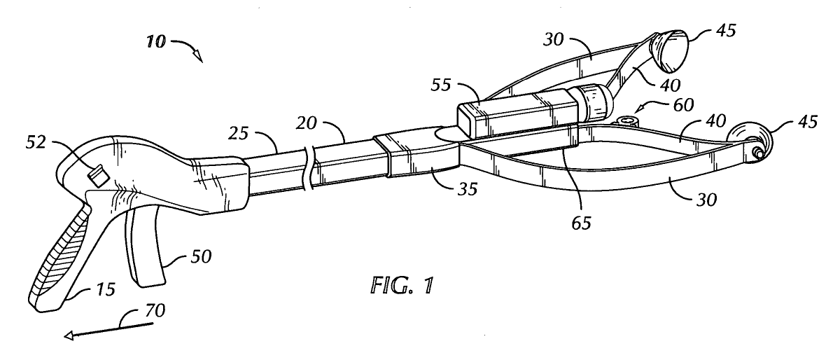

FIG. 1 is a perspective view of pick-up tool 10, which is shown having handle 15 attached to elongated hollow body 20 at proximal end 25. First and second pick-up fingers 30 may be attached at their proximal ends to an outside portion of the body using a suitable fastening device or technique including rivets, welding, bolt and nut combinations, straps, clamps, and the like. If desired, cover 35 may be used to conceal the interface between the pick-up fingers and the body, and may additionally aid in the fastening of the pick-up fingers to the body.

In general, separate linkages respectively extend from each engagement element, shown in FIG. 1 as cup 45. Both cups are effectively coupled to trigger 50 using linkage components. For example, in the embodiment of FIG. 1, linkages 40 each extend from a separate cup and pass through at least a portion of the interior of body 20. Both linkages may be attached to a separate linkage component which passes through the hollow body and is coupled to trigger 50. Alternatively, linkages 40 may each directly couple to the trigger. The trigger may be pivotally mounted at proximal end 25 of the body so that the trigger pulls the linkages 40 rearward when the trigger is squeezed by a user. Optional thumb lock 52 may be used to secure the pick-up tool in the closed position.

Pick-up tool 10 is also shown having a lighting assembly composed of light element 55, an electrical switch (not shown in this figure), and magnet 60. The light element is selectively actuated and will be termed herein as a “flashlight” without attaching any special meaning to that term. The flashlight may be coupled to distal end 65 of the body. The magnet is shown secured to an inner side of one of the linkages 40, such that the magnet is located proximate to the flashlight, and more particularly, to the electrical switch, when the pick-up tool is in the open position. Flashlight 55 and magnet 60 may be secured to their respective components of the pick-up tool using a suitable fastener including adhesives, clamps, hook and loop materials such as Velcro, straps, and the like.

The engagements elements, such as cups 45, may be formed from an assortment of different materials which allows the pick-up tool to grasp or otherwise engage an item of interest such as, for example, trash, books, coins, clothing, food items, garden debris, and the like. Possible engagement elements include arrangements such as cups, claws, arms, scoops, calipers, tongs, blades, and the like. Suitable materials for the engagement elements include rubber, plastic, metal, and alloys, among others. In the embodiment illustrated in FIG. 1, the cups may have a diameter of about 0.5-2.5 inches, or more. However, the cups may be dimensioned to facilitate the retrieval of particular types of items such as cans, books, rocks, coins, golf balls, tennis balls, and the like.

Body 20, fingers 30, and linkages 40 may be formed from any suitably ridged material such as aluminum, steel, steel-alloy, plastic, and the like. The overall length of pick-up tool 10 is typically dependent upon the type of environment (for example, household, office, medical facility, outdoor garden, roadside, garage, golf course, tennis courts, and the like), in which the pick-up tool is to be used. Other applications include the retrieval of items from water (for example, swimming pools and ponds), and from elevated locations such as trees and building roofs and rafters. The pick-up tool may therefore be sized to accommodate such uses, and consequently may have an overall length of about 1-7 feet, or more.

Handle 15 and trigger 20 may be constructed any suitably ridged material. For instance the handle may be formed from two injection-molded, half-handles, which are attached together with rivets, screws, or other types of fasteners. The trigger may be constructed in a similar fashion.

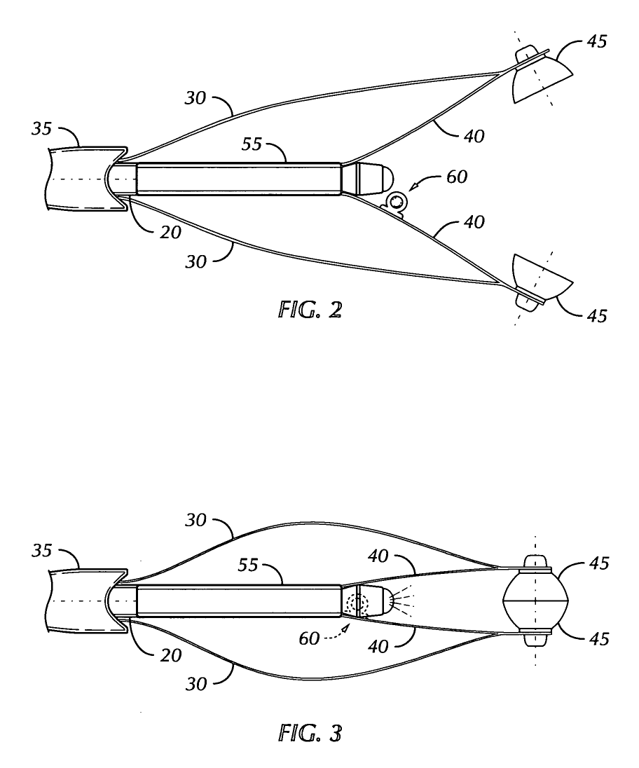

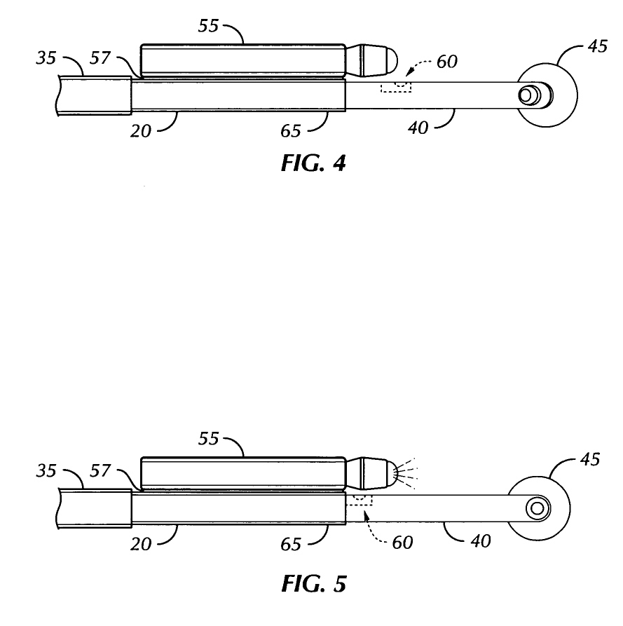

Exemplary operation of pick-up tool 10 will be now be described with additional reference to FIGS. 2 through 5. FIGS. 2 and 4 are close-up top and side views, respectively, of the distal end of the pick-up tool in the open position. Conversely, FIGS. 3 and 5 are close-up top and side views, respectively, of the same pick-up tool, but in the closed position.

To operate the pick-up tool, a user may first grasp the pick-up tool by handle 15 while locating the item for retrieval. As previously noted, situations may arise in which the user is forced to locate an object for retrieval in a dimly lit or dark area. Examples of such areas include closets, attics or crawlspaces, under a bed, behind furniture, tool sheds, pantries, outdoors at night, and the like.

Flashlight 55 is shown secured to the body using adhesive 57, and may be used to assist users in providing desired illumination. For instance, to activate the flashlight, the user may squeeze trigger 50 in direction 70. This causes the rearward pull of linkages 40, resulting in at least a portion of the linkages to withdraw into proximal end 65 of the hollow body. Since magnet 60 is attached to one of the linkages, it also moves inwardly toward the proximal end. Ultimately, the magnet reaches an effectively close location adjacent to flashlight 55. In accordance with an embodiment, the magnet interacts with a cooperating electrical switch housed within, for example, the flashlight. Whenever the magnet is placed in close physical proximity to the switch, such as that illustrated in FIGS. 3 and 5, the switch causes the flashlight to emit light. A timing circuit within the flashlight maintains the light on or actuated for a predetermined period of time.

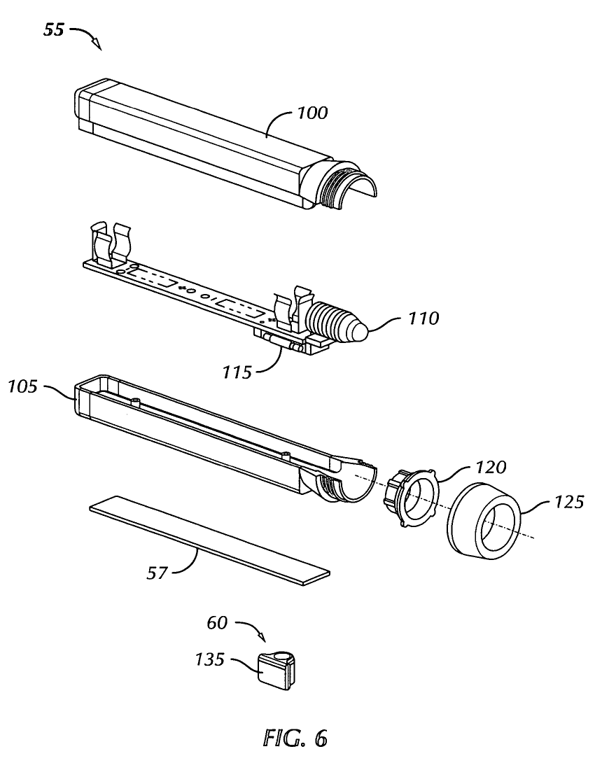

After the light is actuated, the user may release the trigger and the cups will disengage, as shown in FIGS. 2 and 4. Even though magnet 60 is no longer positioned near the electrical switch associated with the flashlight, the flashlight remains illuminated for a predetermined length of time (10-60 seconds being typical, but it could 0-60 seconds). The length of time that the flashlight remains activated may be controlled using a conventional time delay circuit, such as a resistor/capacitor (R/C) time delay circuit. Note that 60 seconds is specified here only for practical reasons. It could be longer if desired. This enables the user to see the object to be picked up, even though the engagement elements, or cups, are separated, awaiting the trigger to be squeezed to pick up the object. The just-described process of squeezing and releasing trigger 50 may be repeated as often as necessary to provide additional time periods of illumination. The specifics relating to the electrical switch are discussed in more detail in conjunction with FIG. 6.

An advantage provided by pick-up tool 10 is that the user does not have to utilize a separate lighting device when using the pick-up tool in dimly lit areas. This allows the user to manipulate the pick-up tool with one hand, leaving their other hand free. Another benefit is that the flashlight may be activated using the same action which would be required for holding the pick-up tool and retrieving an object. This simplifies the activation of the flashlight since the user does not have to locate a separate flashlight on/off switch. This is especially important when using the pick-up tool in darkened conditions which would make finding the on/off switch difficult.

FIG. 6 is an exploded perspective view of the various components of an exemplary lighting assembly which may be used in conjunction with, for example, the pick-up tool illustrated in FIG. 1. Flashlight 55 includes upper and lower housings 100 and 105, which collectively contain lamp 110 and associated electrical switch 15. Conventional reflector 120 is positioned within the upper and lower housings, relative to the lamp. Connector 125 engages cooperating threading located on the upper and lower housings. Adhesive 57 may be used to secure the flashlight to body 20, for example. The adhesive may be any type, including a dual sided peel-and-stick tape or sheet. Magnet 60 is shown housed in housing 135, which facilitates the attachment of this component to linkage 40. The magnet may be similarly secured to the linkage. The flashlight may be powered using any suitable DC power source (not shown), such as one or more AA or AAA sized batteries, for example.

In general, switch 115, which will also be referred to as a proximity switch, may be implemented using known technologies which can sense, react to, or otherwise detect the relative proximity of a sensed device or component. An example of such a sensed device is magnet 60. In accordance with an embodiment, switch 115 may be implemented as a reed switch. A reed switch is typically composed of an electric switch having a pair of ferrous metal contacts in a hermetically sealed glass envelope. During use, these contacts will pull together and complete an electrical circuit, which activates lamp 110, whenever the magnet is placed in close proximity to the switch (FIG. 3). That is, whenever a user squeezes trigger 50, the attached linkages 40 are pulled inwardly, causing attached magnet 60 to be repositioned in close proximity to switch 115.

In accordance with an embodiment, magnet 60 may be alternatively located on one of the fingers 30. In this embodiment, pulling of the trigger would cause the finger having the magnet to move inwardly toward body 20. This action would actuate flashlight 55 in a manner similar to that described above.

If desired, switch 115 may be further configured with manual override capabilities. This enables a user to turn the flashlight on or off manually, regardless of the relative positioning of the magnet and switch. Alternatively or additionally, the timing circuit associated with switch 115 may also be configured with a knob or slider switch, for example, which permits a user to manually specify the total elapsed time for which the flashlight remains activated. While the preferred embodiment is to have the light remain on for some period of time after it is actuated, embodiments of the invention contemplate a light that goes on and off by activating the trigger. Another possibility is to remotely mount switch 115 relative to the flashlight. In such embodiments, the flashlight need not be positioned in close proximity to the magnet.

The figures show pick-up tool 10 having linkages 40 which pass through the center of body 20. One possible alternative is to route the linkages along the outside of some or all of the body. In such an embodiment, fingers 30 may be structured to permit the linkages to pass the location at which the fingers are attached to the body.

Various embodiments have been described in which the lighting assembly has been implemented as a conventional flashlight using a lamp for illumination. However, other lighting elements or devices (for example, light emitting diodes (LEDs), vertical cavity surface emitting lasers (VCSELs), and the like) are possible and within the teachings of the present disclosure.

The present disclosure provides various examples of pick-up tools which may be configured with a lighting assembly in accordance with the present invention. The EZ Grabber, the EZ Reacher, and the EZ Assist Reacher, all developed by ARCOA Industries of San Marcos, Calif., are several such pick-up tools that may be adapted in accordance with the invention for use with the lighting assemblies disclosed herein. Further examples of pick-up tools which may implement a lighting assembly in accordance with the invention are disclosed in U.S. Pat. Nos. 4,962,957 and 5,577,785, which are both assigned to the assignee of the present invention.

While the invention has been described in detail with reference to disclosed embodiments, various modifications within the scope of the invention will be apparent to those of ordinary skill in this technological field. It is to be appreciated that features described with respect to one embodiment typically may be applied to other embodiments. Therefore, the invention properly is to be construed only with reference to the claims.

What is claimed is:

1. A pick-up tool, comprising:
an elongated body having first and second pick-up fingers extending divergently outward from a distal end of said body, and a handle coupled to a proximal end of said body;
engagement elements individually located at terminating outer ends of each of said first and second pick-up fingers;
first and second linkages respectively extending from said first and second pick-up fingers;
a lighting element coupled to said body;
a sensed device coupled to said first linkage;
a proximity switch coupled to said distal end of said body, said proximity switch causing said lighting element to emit light upon detecting said sensed device at an effectively close distance relative to said proximity switch; and
a control component pivotally coupled to said body for drawing said first and second linkages rearward, causing said engagement elements to move closer together, and substantially simultaneously causing said sensed device to effectively engage said proximity switch.

2. The pick-up tool according to claim 1, wherein said proximity switch causes said lighting element to emit light for a predetermined period of time.

3. The pick-up tool according to claim 2, wherein said predetermined time is about 0-60 seconds.

4. The pick-up tool according to claim 2, wherein said predetermined time is at least 5 seconds.

5. The pick-up tool according to claim 2, wherein said predetermined time is user-adjustable.

6. The pick-up tool according to claim 1, wherein said sensed device includes a magnet.

7. The pick-up tool according to claim 1, wherein said proximity switch is a reed switch.

8. The pick-up tool according to claim 1, further comprising:
a manual switch for activating or deactivating said lighting element, regardless of the relative spatial relationship between said sensed device and said proximity switch.

9. The pick-up tool according to claim 1, wherein said lighting element is selected from the group consisting of a lamp, a light emitting diode (LED), and a vertical cavity surface emitting laser (VCSEL).

10. The pick-up tool according to claim 1, wherein said engagement elements each include a rubber cup.

11. The pick-up tool according to claim 1, wherein said body is formed from plastic.

12. The pick-up tool according to claim 1, wherein said body is formed from aluminum.

13. The pick-up tool according to claim 1, wherein said proximity switch is physically coupled to a housing which contains said lighting element.

14. The pick-up tool according to claim 1, wherein said control component is a trigger effectively linked to said first and second linkages.

15. A lighting assembly for use with a pick-up tool having linkage which slideably projects from a body and is coupled to opposing engagement elements, said pick-up tool including a pivoting control component providing user control of said engagement elements via said linkage, said lighting assembly comprising:
a lighting element for coupling to said body;
a sensed device for coupling to said linkage; and
a proximity switch for coupling to said body, said proximity switch causing said lighting element to emit light upon detecting said sensed device at an effective close distance relative to said proximity switch.

16. The lighting assembly according to claim 15, wherein said proximity switch causes said lighting element to emit light for a predetermined period of time.

17. The lighting assembly according to claim 16, wherein said predetermined time is about 0-60 seconds.

18. The lighting assembly according to claim 16, wherein said predetermined time is at least 5 seconds.

19. The lighting assembly according to claim 16, wherein said predetermined time is user-adjustable.

20. The lighting assembly according to claim 16, wherein said sensed device includes a magnet.

21. The lighting assembly according to claim 15, wherein said proximity switch is a reed switch.

22. The lighting assembly according to claim 15, wherein said lighting element is selected from the group consisting of a lamp, a light emitting diode (LED), and a vertical cavity surface emitting laser (VCSEL).

23. The lighting assembly according to claim 15, wherein said proximity switch is physically coupled to a housing which contains said lighting element.

24. The lighting assembly according to claim 15, wherein said control component is a trigger effectively linked to said linkage.

25. A pick-up tool, comprising:
an elongated body having first and second pick-up fingers extending divergently outward from a distal end of said body;
means for engaging objects, individually located at terminating outer ends of each of said first and second pick-up fingers;
means for linking said first and second pick-up fingers with a control component;
selectively actuable means for lighting coupled to said body;
means for detecting proximity of a sensed device coupled to said means for linking; and
means for drawing said means for linking rearward, said means for drawing causing said means for engaging objects to move closer together, and substantially simultaneously causing said sensed device to effectively engage said means for detecting proximity, resulting in said means for lighting to emit light.

26. A pick-up tool, comprising:
an elongated body having first and second pick-up fingers extending divergently outward from a distal end of said body, and a handle coupled to a proximal end of said body;
engagement elements individually located at terminating outer ends of each of said first and second pick-up fingers;
first and second linkages respectively extending from said first and second pick-up fingers;
a lighting element coupled to said body;
a sensed device coupled to said first pick-up finger;
a proximity switch coupled to said distal end of said body, said proximity switch causing said lighting element to emit light upon detecting said sensed device at an effective close distance relative to said proximity switch; and
a control component pivotally coupled to said body for drawing said first and second linkages rearward, causing said engagement elements to move closer together, and substantially simultaneously causing said sensed device to effectively engage said proximity switch.

27. A method for activating a light element of a pick-up tool having linkage which slideably projects from a body and is coupled to opposing engagement elements, said pick-up tool including a pivoting control component providing user control of said engagement elements via said linkage, said method comprising:
detecting proximity of a sensed device coupled to said linkage, relative to a switch associated with said body; and
actuating said light element upon an occurrence of said detecting.
